(19) United States
(12) Patent Application Publication
(10) Pub. No.: US 2026/0319402 A1
(43) Pub. Date: Oct. 15, 2026

(54) FIXING DEVICE AND IMAGE FORMING APPARATUS

(71) Applicant: KYOCERA Document Solutions Inc., Osaka (JP)

(72) Inventors: Daisuke SUGIOKA, Osaka (JP); Shota ONISHI, Osaka (JP); Yuki UOHASHI, Osaka (JP)

(73) Assignee: KYOCERA Document Solutions Inc., Osaka (JP)

(21) Appl. No.: 19/636,124

(22) Filed: Apr. 1, 2026

(30) Foreign Application Priority Data
Apr. 9, 2025 (JP) 2025-064564

(51) Int. Cl. G03G 15/20

(52) U.S. Cl. CPC G03G 15/2028; G03G 15/2064; G03G 2215/2025

(57) ABSTRACT

A fixing device includes a fixing member, a pressure member, and an entry guide member. The entry guide member has a guide surface. The entry guide member includes a first guide surface portion and a second guide surface portion. The first guide surface portion extends along a part of a circumference of a first circular shape having a center closer to the fixing member than a fixing straight line extending a straight line connecting an upstream end and a downstream end of the pressurizing region. The second guide surface portion continuous to a downstream side of the first guide surface portion, and extends along a part of a circumference of a second circular shape having a center closer to the pressure member than the fixing straight line. A curvature of the second guide surface portion is larger than a curvature of the first guide surface portion.

### INCORPORATION BY REFERENCE

This application is based on and claims the benefit of priority from Japanese patent application No. 2025-064564 filed on Apr. 9, 2025 which is incorporated by reference in its entirety.

### BACKGROUND

The present disclosure relates to a fixing device which fixes a toner image on a medium and an image forming apparatus.

An electrophotographic image forming apparatus includes a transfer member for transferring a toner image carried on an image carrier to a sheet, and a fixing device for fixing the toner image to the sheet. The fixing device is provided with a guide member for guiding the sheet to the fixing nip. The guide member includes a guide plate rotatably supported and a biasing member for biasing the guide plate to the upstream side in the rotational direction of the heating member. In the image forming apparatus, in order to stably guide the sheet to the fixing nip, a detection part detects the position of the guide member, and a control part predicts the sheet conveying route based on the detected position of the guide member, and adjusts the conveyance speed of the sheet at the fixing nip.

### SUMMARY

A fixing device according to the present disclosure includes a fixing member, a pressure member, and an entry guide member. The fixing member heats a toner on a medium while rotating around an axis. The pressure member forms a pressurizing region between the fixing member and the pressure member, and pressures the toner on the medium conveyed through the pressurizing region while rotating around an axis. The entry guide member is immovably provided on an upstream side of the pressurizing region in a conveying direction of the medium, and has a guide surface which guides the medium conveyed toward the pressurizing region. The guide surface of the entry guide member includes a first guide surface portion and a second guide surface portion. The first guide surface portion extends along a part of a circumference of a first circular shape having a center closer to the fixing member than a fixing straight line obtained by extending a straight line connecting an upstream end and a downstream end of the pressurizing region in the conveying direction. The second guide surface portion continuous to a downstream side of the first guide surface portion in the conveying direction, and extends along a part of a circumference of a second circular shape having a center closer to the pressure member than the fixing straight line. A curvature of the second guide surface portion is larger than a curvature of the first guide surface portion.

An image forming apparatus according to the present disclosure includes the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus according to one embodiment of the present disclosure.

FIG. 2 is a cross-sectional view taken along the line II-II of FIG. 1.

FIG. 3 is a side view (cross-sectional view) showing a fixing device and a transfer roller according to the embodiment of the present disclosure.

FIG. 4 is a side view (cross-sectional view) showing the fixing device according to the embodiment of the present disclosure.

FIG. 5 is an enlarged side view (cross-sectional view) of a part of the fixing device according to the embodiment of the present disclosure.

FIG. 6 is a side view (cross-sectional view) explaining an operation of an entry guide member of the fixing device according to the embodiment of the present disclosure.

### DETAILED DESCRIPTION

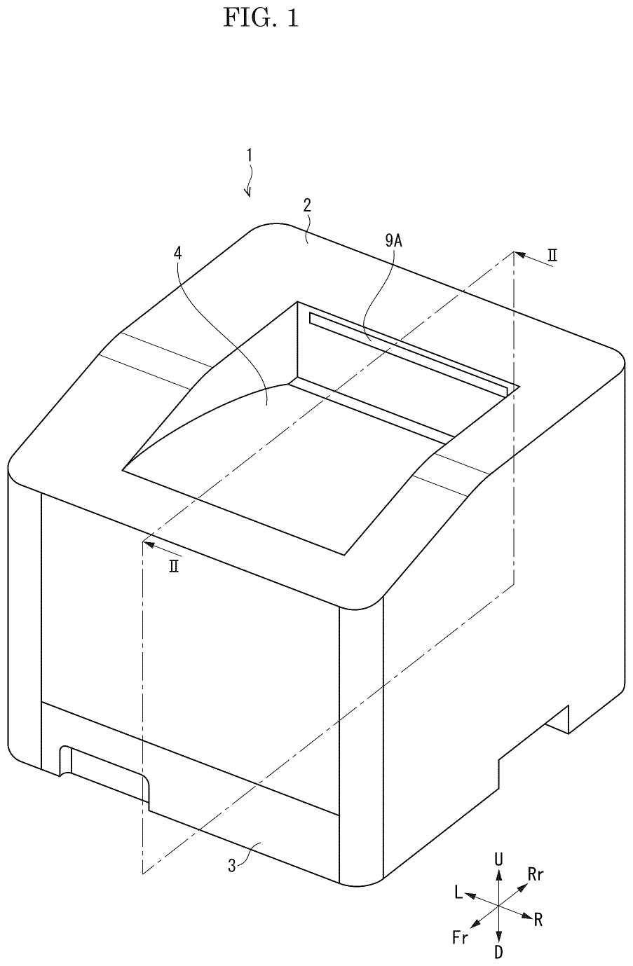

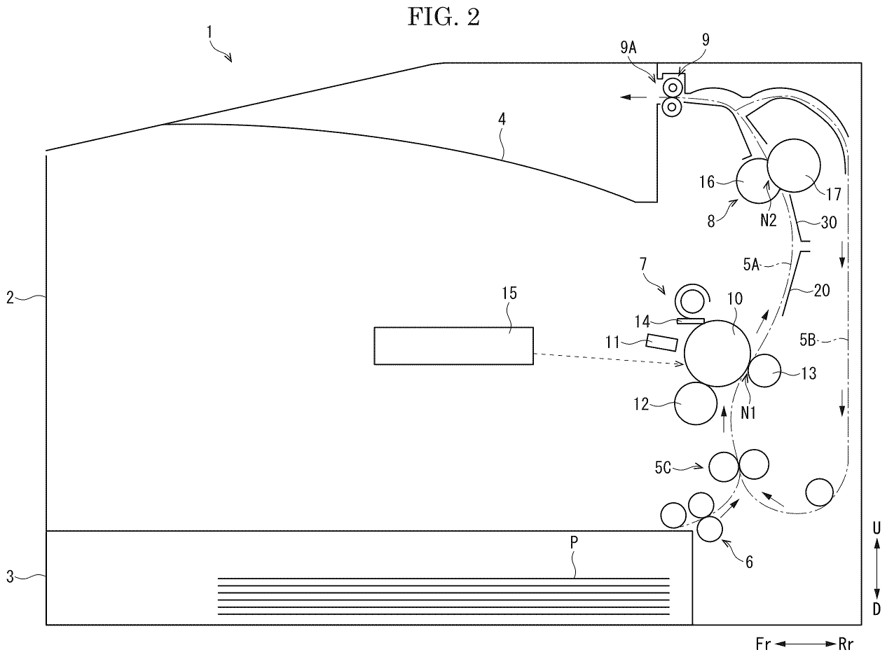

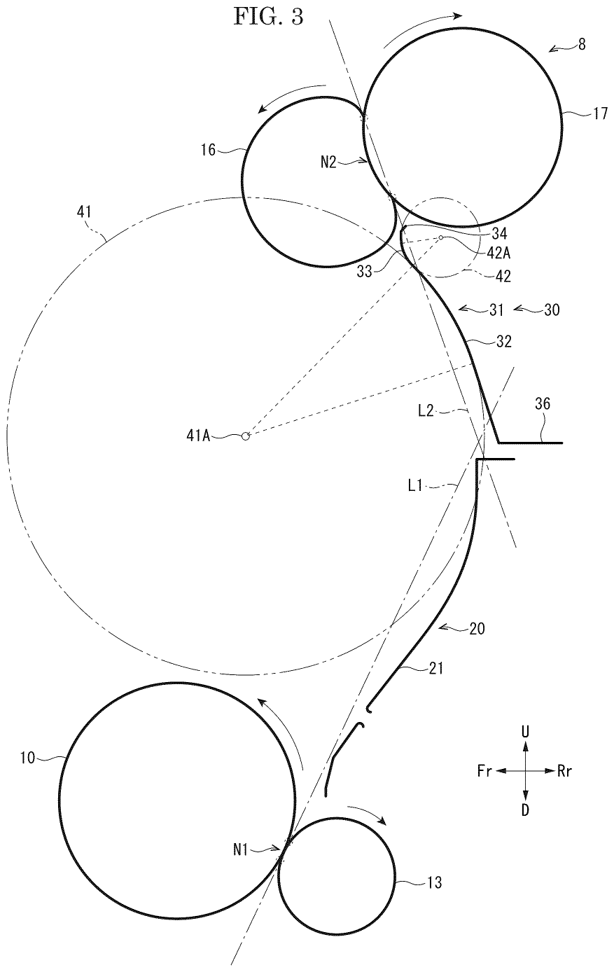

Hereinafter, with the attached drawings, an embodiment of the present disclosure will be described. Fr, Rr, L, R, U, and D in the drawings indicate the front, rear, left, right, upper, and down. The front-and-rear direction, the left-and-right direction and the upper-and-down direction are orthogonal to each other. Although the terms showing the direction and position are used in the specification, they are used for convenience of description and are not intended to limit the scope of the disclosure. In the drawings, the shapes, dimensions, angles, positions, and the like of the constituent members are not necessarily accurate and are schematized for the purpose of explanation.

[Image Forming Apparatus] With reference to FIG. 1 to FIG. 3, the image forming apparatus 1 will be described. FIG. 1 is a perspective view showing the image forming apparatus 1. FIG. 2 is a cross-sectional view taken along the line II-II of FIG. 1. FIG. 3 is a side view (cross-sectional view) showing the fixing device 8 and the transfer roller 13.

The image forming apparatus 1 is a printer which forms an image by transferring a toner image formed by an electrophotographic method to a paper sheet P (medium). As shown in FIG. 1, the image forming apparatus 1 includes a housing 2 having a substantially rectangular parallelepiped appearance. In the lower portion in the housing 2, a sheet feeding cassette 3 which stores the paper sheet P is detachably provided on the upper portion of the housing, a discharge tray 4 to which the paper sheet P is discharged is provided. The housing 2 includes a metal frame and a synthetic resin member fixed to the frame. The paper sheet P as an example of the medium is not limited to a paper sheet, but may be a sheet made of resin or the like.

As shown in FIG. 2, a conveying path 5A serving as a path along which the paper sheet P is conveyed from the sheet feeding cassette 3 to the discharge tray 4 is formed inside the housing 2. The conveying path 5A is formed in a substantially S-shape from the rear lower portion to the rear upper portion of the housing 2. In the rear portion of the housing 2, an inversion conveying path 5B which branches at the upper portion (downstream side) of the conveying path 5A and merges with the lower portion (upstream side) of the conveying path 5A. In this specification, the terms “upstream”, “downstream”, and similar terms refer to “upstream”, “downstream”, and similar concepts in the conveying direction of the paper sheet P.

A sheet feeding device 6 which feeds the paper sheet P stored in the sheet feeding cassette 3 to the conveying path 5A is provided at the upstream end of the conveying path 5A (near the sheet feeding cassette 3). On the downstream side of the sheet feeding device 6 of the conveying path 5A, a pair of registration rollers 5C for temporarily blocking the paper sheet P to be conveyed and correcting the skew of the paper sheet P (skew correction) is provided. A pair of discharge rollers 9 for discharging the paper sheet P from a discharge port 9A formed in the upper portion of the housing 2 toward the discharge tray 4 is provided at the downstream end of the conveying path 5A.

As shown in FIG. 2, an image forming device 7 and a fixing device 8 are provided inside the housing 2. The image forming device 7 is provided on the downstream side of the sheet feeding device 6 and forms a toner image on the paper sheet P to be conveyed. The fixing device 8 is provided on the downstream side of the image forming device 7 (a transfer region N1 described later), and thermally fixes the toner image on the paper sheet P (a fixing operation).

<Image Forming Device> The image forming device 7 includes a photosensitive drum 10, a charging device 11, a developing device 12, a transfer roller 13, a cleaning device 14, and an optical scanning device 15. Although not shown, a toner container housing replenishing toner (developer) is detachably provided in the housing 2. The toner container is connected to the developing device 12 via a supply pipe, and supplies the toner to the developing device 12.

The photosensitive drum 10 as an example of the image carrier is formed in a substantially cylindrical shape long in the left-and-right direction, and is driven by a motor (not shown) to rotate around an axis (see the arrow shown in FIG. 3). The charging device 11, the developing device 12, the transfer roller 13, and the cleaning device 14 are arranged around the photosensitive drum 10 in the order of the image forming process. The transfer roller as an example of the transfer member is provided rotatably around an axis, is in contact with the photosensitive drum 10, and forms a transfer region N1 between the transfer roller 13 and the photosensitive drum 10. The transfer region N1 refers to a region from an upstream position where the pressure is 0 Pa to a downstream position where the pressure becomes 0 Pa again via a position where the pressure acts. A conveying guide member 20 is provided on the downstream of the transfer region N1. The conveying guide member 20 is fixed to the housing 2 (frame) and has a conveying guide surface 21 (see FIG. 3) which guides the paper sheet P that has passed through the transfer region N1.

<Fixing Device> As shown in FIG. 2, the fixing device 8 includes a fixing belt 16, a pressure roller 17, and an entry guide member 30.

<Fixing Belt> The fixing belt 16 as an example of the fixing member is made of flexible material, and has a substantially cylindrical shape long in the left-and-right direction. The fixing belt 16 is supported, for example, by a fixing frame (not shown) fixed to the housing 2 so as to be rotatable around an axis. A heater (not shown) for heating the fixing belt 25 is provided in the hollow portion of the fixing belt 16. The heater may be, for example, a halogen lamp or a heating substrate having a heating resistor.

<Pressure Roller> A pressure roller 17 as an example of the pressure member is formed in a substantially cylindrical shape long in the left-and-right direction, and forms a pressurizing region N2 between the pressure roller 17 and the fixing belt 16. The pressure roller 17 is supported by the fixing frame so as to be rotatable around an axis. The pressure roller 17 is driven by a motor (not shown) to rotate around the axis, and the fixing belt 25 is driven by the pressure roller 17 to rotate (see the arrows shown in FIG. 3). The pressurizing region N2 refers to a region from an upstream position where the pressure is 0 Pa to a downstream position where the pressure becomes 0 Pa again via a position where the pressure acts.

<Entry Guide Member> The entry guide member 30 is made of, for example, synthetic resin excellent in heat resistance and wear resistance. The entry guide member 30 is fixed to the fixing frame on the upstream of the fixing belt 16 and the pressure roller 17. That is, the entry guide member 30 is immovably provided on the upstream of the pressurizing region N2. The entry guide member 30 includes a guide surface 31 (see FIG. 3) which guides the paper sheet P conveyed toward the pressurizing region N2. The conveying guide member 20 and the entry guide member 30 constitute the conveying path 5A between the transfer region N1 and the pressurizing region N2. The conveying guide surface 21 of the conveying guide member 20 and the guide surface 31 of the entry guide member 30 are surfaces with which the paper sheet P to be conveyed comes into contact. The sheet P passing through the transfer region N1 is conveyed while contacting with a part of the conveying guide surface 21 and a part of the guide surface 31.

[Image Forming Processing] The operation of the image forming apparatus 1 will be described. A control device (not shown) for integrally controlling the image forming apparatus 1 executes the image forming processing (control) based on image data input from an external terminal, for example, as follows.

The charging device 11 charges the surface of the photosensitive drum 10. The optical scanning device 15 emits scanning light toward the photosensitive drum 10 to form an electrostatic latent image corresponding to the image data on the surface of the photosensitive drum 10. The developing device 12 develops the electrostatic latent image on the photosensitive drum 10 into a toner image by using the toner supplied from the toner container. The photosensitive drum 10 carries the toner image while rotating around the axis. The sheet feeding device 6 separates the paper sheet P in the sheet feeding cassette 3 one by one and feeds them to the conveying path 5A. The paper sheet P is conveyed along the conveying path 5A and the skew is corrected by the pair of registration rollers 5C. The transfer roller 13 transfers the toner image on the photosensitive drum 10 to the paper sheet P conveyed in the transfer region N1 while rotating around the axis. Thereafter, the cleaning device 14 removes the toner remaining on the photosensitive drum 10.

The fixing belt 16 heats the toner (toner image) on the paper sheet P conveyed in the pressurizing region N while rotating around the axis. The pressure roller 17 pressurizes the toner on the paper sheet P conveyed in the pressurizing region N while rotating around the axis. Then, the toner image is fixed to the paper sheet P, and the fixed image is formed on the paper sheet P. The sheet P on which the image is fixed is discharged to the discharge tray 4. In the case of single-sided printing, the pair of discharge rollers 9 discharges the sheet P passing through the pressurizing region N2 through the discharge port 9A toward the discharge tray 4.

In the case of double-sided printing, the sheet P passing through the fixing device 8 is switched back at the downstream side of the conveying path 5A and conveyed to the inversion conveying path 5B. The sheet P is returned from the inversion conveying path 5B to the conveying path 5A again, and is conveyed to the transfer region N1 after being the skew corrected by the pair of registration rollers 5C. Thereafter, the toner image is transferred to the paper sheet P, thermally fixed, and the double-sided printed paper P is discharged to the discharge tray 4.

The image forming apparatus 1 according to the present embodiment achieves miniaturization (reduction in height of the housing 2 (reduction in height)) by curving the conveying path 5A in a substantially S-shape. Specifically, as shown in FIG. 3, the conveying guide member 20 (conveying guide surface 21) and the entry guide member 30 (guide surface 31) are disposed in an inclined posture opposite to each other. In other words, a transfer straight line L1 obtained by extending a straight line connecting the upstream end and the downstream end of the transfer region N1 in the conveying direction is inclined rearward from below to above as viewed from the side surface. A fixing straight line L2 obtained by extending a straight line connecting the upstream end and the downstream end of the pressurizing region N2 in the conveying direction is inclined forward from below to above as viewed from the side surface. The transfer straight line L1 and the fixing straight line L2 are inclined in opposite directions when viewed from the side surface (axial direction). The transfer straight line L1 and the fixing straight line L2 intersect in the middle of the conveying path 5A between the transfer region N1 and the pressurizing region N2. The transfer straight line L1 may be regarded as a tangent line passing through a position (point) at which the maximum pressure acts in the transfer region N1. Similarly, the fixing straight line L2 may be regarded as a tangent line passing through a position (point) where the maximum pressure acts in the pressurizing region N2.

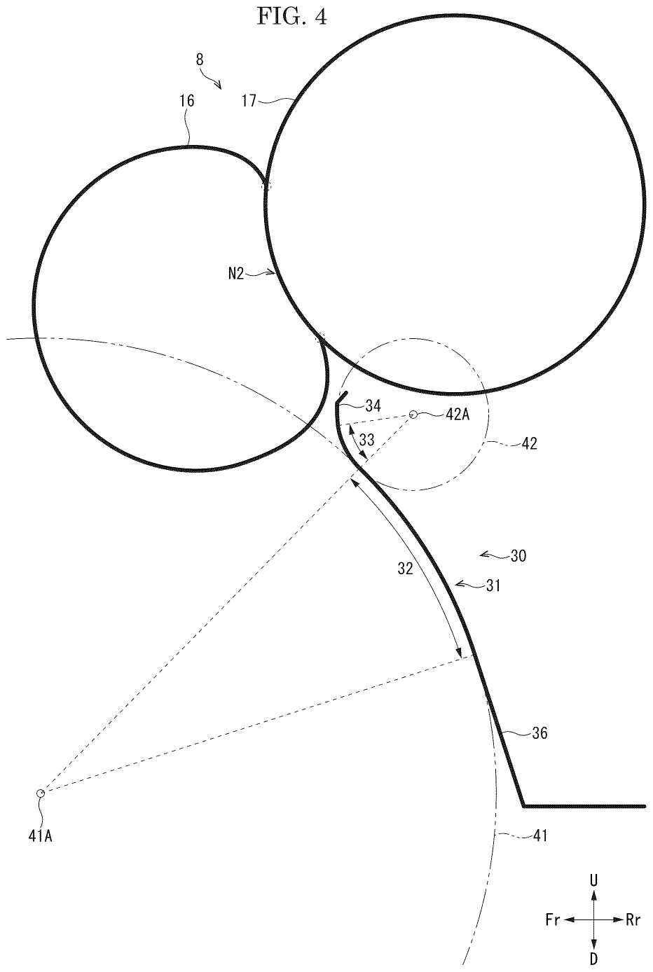

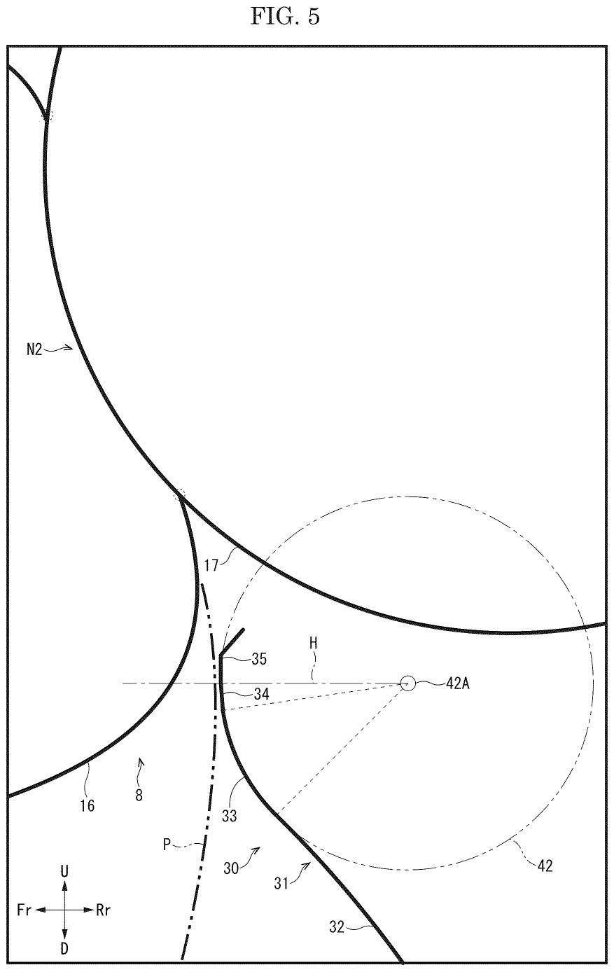

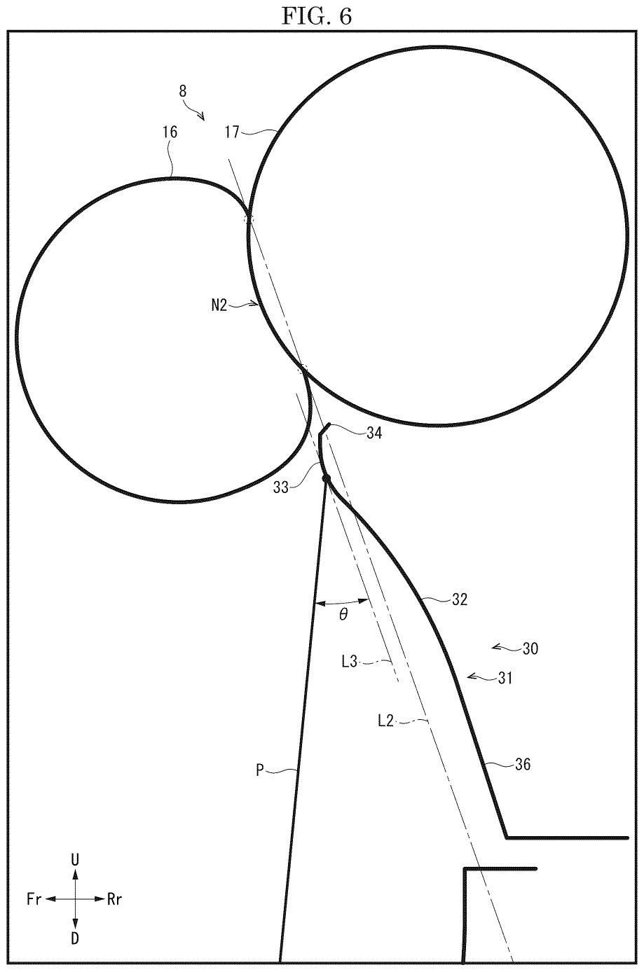

According to the above configuration, the linear distance between the transfer region N1 and the pressurizing region N2 can be shortened as compared with the case where, for example, the two conveying guide members 20 and 30 are arranged in a row in the upper-and-lower direction. Further, even if the linear distance is shortened, a path length necessary for arranging the entry guide member 30 between the transfer region N1 and the pressurizing region N2 can be secured. Thus, the size of the image forming apparatus 1 can be reduced (the height of the housing 2 can be reduced).

[Problems Due to Miniaturization] When the configuration in which the transfer straight line L1 and the fixing straight line L2 are inclined in opposite directions to each other (a configuration in which the conveying path 5A is curved) is adopted in accordance with the miniaturization of the image forming apparatus 1 (the height of the housing 2 is reduced), a conveying failure (paper sheet jam) of the paper sheet P called a jam is likely to occur at the upstream end portion of the pressurizing region N2. More specifically, when the leading edge of the paper sheet P passing through the transfer region N1 collides with the guide surface 31 of the entry guide member 30, a phenomenon called “floating (of the paper sheet)” in which the paper sheet P separates from the guide surface 31 may occur. The floating of the paper sheet P is likely to occur, for example, when the paper sheet P having a strong stiffness (rigidity) such as a thick paper sheet or a small-sized paper sheet is conveyed. When the floating of the paper sheet P occurs, the leading edge of the paper sheet P is not properly directed to the pressurizing region N2, so that the jam may occur at the upstream end of the pressurizing region N2.

[Problems Due to Paper Moisture Content] Further, when the moisture amount (moisture content) contained in the paper sheet P is large, the adhesion of the toner image transferred to the paper sheet P may be weakened. Therefore, when the paper sheet P having a high moisture content passes through the pressurizing region N2 of the fixing device 8, an image defect called “tailing” in which the toner image having a weak adhesion force is disturbed on the paper sheet P may occur.

[Guide Surface of Entry Guide Member] The entry guide member 30 of the fixing device 8 according to the present embodiment includes the guide surface 31 which suppresses the floating of the paper sheet S and the trailing. The guide surface 31 of the entry guide member 30 will be described with reference to FIG. 3 to FIG. 5. FIG. 4 is a side view (cross-sectional view) showing the fixing device 8. FIG. 5 is an enlarged side view (cross-sectional view) showing a part of the fixing device 8. In FIG. 3 to FIG. 5 (FIG. 6 to be described later), the entry guide member 30 (conveying guide member 20) is shown by one thick line mainly for the purpose of explaining the feature of the guide surface 31 of the entry guide member 30, but actually, the entry guide member 30 (conveying guide member 20) is a three-dimensional member having a thickness.

As shown in FIG. 3, the guide surface 31 of the entry guide member 30 has a first guide surface portion 32, a second guide surface portion 33, and a third guide surface portion 34. The first guide surface portion 32, the second guide surface portion 33, and the third guide surface portion 34 are smoothly continuous without interposing joints, steps, or the like.

<First Guide Surface Portion> As shown in FIG. 3 and FIG. 4, the first guide surface portion 32 is formed along a part (arc) of the circumference of a first circular shape 41 having a center 41A closer to (forward) the fixing belt 16 than the fixing straight line L2. The first guide surface portion 32 is a curved surface extending upward while curving forward. Although a substantially planar auxiliary surface portion 36 is continuous on the upstream of the first guide surface portion 32, the auxiliary surface portion 36 may be omitted.

<Second Guide Surface Portion> As shown in FIG. 3 and FIG. 4, the second guide surface portion 33 is continuous to the downstream side of the first guide surface portion 32. The second guide surface portion 33 is formed along a part (arc) of the circumference of a second circular shape 42 having a center 42A closer to (rearward) the pressure roller 17 than the fixing straight line L2. The second guide surface portion 33 is a curved surface curved rearward and upward. The second guide surface portion 33 is a curved surface opposite to the first guide surface portion 32, and the first guide surface portion 32 and the second guide surface portion 33 form a substantially S-shaped curved surface. The second guide surface portion 33 mainly has a function of suppressing floating of the paper sheet P. The intersection point of a straight line connecting the center 41A of the first circular shape 41 and the center 42A of the second circular shape 42 and the guide surface 31 is the inflection point of the first guide surface portion 32 and the second guide surface portion 33.

The center 42A of the second circular shape 42 is located on the downstream (upper) of the center 41A of the first circular shape 41. The radius of the first circular shape 41 (the radius of curvature of the first guide surface portion 32) is set to, for example, about 6 times the radius of the second circular shape 42 (the radius of curvature of the second guide surface portion 33). That is, the curvature of the second guide surface portion 33 is set to be larger than the curvature of the first guide surface portion 32.

<Third Guide Surface Portion> As shown in FIG. 3 and FIG. 4, the third guide surface portion 34 is continuous to the downstream side of the second guide surface portion 33. When viewed from the side, the third guide surface portion 34 extends from the downstream end of the second guide surface portion 33 to the downstream side (upward), and then bends to the side of the pressure roller 17 (rearward) to be formed into a substantially L-shape. The angle of the bent portion of the third guide surface portion 34 is obtuse. As shown in FIG. 5, the third guide surface portion 34 has a floating region 35 which directs the paper sheet P toward the pressurizing region N2 while floating the paper sheet P (from the third guide surface portion 34). In the case where the fixing straight line L2 (see FIG. 3) is inclined but extends in the vertical direction, the floating region 35 of the third guide surface portion 34 is formed on the downstream side (upper side) of the horizontal line H passing through the center 42A of the second circular shape 42. That is, a region above the horizontal line H of the third guide surface portion 34 is set as the floating region 35. The third guide surface portion 34 (horizontal line H) mainly has a function of suppressing the tailing.

[Guide of Paper Sheet] With reference to FIG. 3 and FIG. 6, the function of the guide surface 31 of the entry guide member 30 to guide the sheet P will be described. FIG. 6 is a side view (cross-sectional view) for explaining the operation of the entry guide member 30 of the fixing device 8.

As shown in FIG. 6, the paper sheet P passing through the transfer region N1 is conveyed downstream, and the leading edge of the paper sheet P comes into contact with the upstream side portion of the second guide surface portion 33 (see the black dot in FIG. 6). At this time, when a tangent line (guide tangent line L3) passing through the contact point between the leading edge of the paper sheet P and the second guide surface portion 33 is drawn, the guide tangent line L3 is substantially parallel to the fixing straight line L2. The angle θ formed by the guide tangent line L3 and the paper sheet P is an acute angle of 30° or less, for example. The floating of the paper sheet P is likely to occur when the angle θ is large (for example, θ=45° or more) in addition to when the sheet P having a strong stiffness is conveyed. This is because when the angle θ is large, the leading edge of the paper sheet P collides with the second guide surface portion 33 at a steep angle (an angle close to a right angle), and the resistance (conveyance load) when the leading edge of the paper P comes into contact with the second guide surface portion 33 increases. Therefore, by setting the second guide surface portion 33 (guide tangent line L3) so as to reduce the angle θ, the paper sheet P is conveyed along the fixing straight line L2, so that the resistance (conveying load) can be reduced.

The paper sheet P is conveyed to the downstream side with its leading edge in contact with the second guide surface portion 33. The leading side of the paper sheet P moves from the second guide surface portion 33 to the third guide surface portion 34, and is separated from the third guide surface portion 34 toward (forward) the fixing belt 16 in the floating region 35 of the third guide surface portion 34. As shown in FIG. 5, the leading edge of the sheet P comes into contact with the surface of the fixing belt 16 near the upstream end portion of the pressurizing region N2. That is, the paper sheet P separated from the third guide surface portion 34 comes into contact with the fixing belt 16 before entering the pressurizing region N2. The paper sheet P is conveyed toward the pressurizing region N2 while being heated by the fixing belt 16 before entering the pressurizing region N2. When the conveying of the paper sheet P proceeds, the reading edge of the paper sheet P enters the pressurizing region N2, and the toner image on the paper sheet P is thermally fixed to the paper sheet P while passing through the pressurizing region N2.

According to the fixing device 8 according to the embodiment described above, since the angle θ (see FIG. 6) between the guide tangent line L3 and the paper sheet P can be reduced, the resistance (conveying load) when the leading edge of the paper sheet P comes into contact with the second guide surface portion 33 can be reduced. As a result, the floating of the paper sheet P from the second guide surface portion 33 is suppressed, so that the leading edge of the paper sheet P can be directed to the pressurizing region N2, and the conveying failure (jam) in the pressurizing region N2 can be suppressed. Further, since the entry guide member 30 is immovably provided, a space in which the entry guide member 30 is moved becomes unnecessary, and a mechanism for moving the entry guide member 30 also becomes unnecessary. Thus, the image forming apparatus 1 can be miniaturized and the manufacturing cost can be reduced with a simple structure. Furthermore, even when the conveying path 5A between the transfer region N1 and the pressurizing region N2 is curved in order to reduce the size of the image forming apparatus 1, the paper sheet P can be properly guided toward the pressurizing region N2 by using the above-described entry guide member 30.

Further, according to the fixing device 8 according to the present embodiment, the leading edge side of the paper sheet P floating (separated) from the third guide surface portion 34 in the floating region 35 can be directed closer to the upstream side in the rotational direction of the fixing belt 16 than the upstream end of the pressurizing region N2 (see FIG. 5). Thus, since the paper sheet P comes into contact with the fixing belt 16 before entering the pressurizing region N2, the moisture contained in the paper sheet P can be evaporated by the heat of the fixing belt 16. As a result, the moisture contained in the paper sheet P is reduced, so that the occurrence of the tailing (defective image) can be suppressed.

In the fixing device 8 according to the present embodiment, the guide surface 31 of the entry guide member 30 has the first to third guide surface portions 32 to 34, but the present disclosure is not limited thereto. The guide surface 31 may have at least the first to second guide surface portions 32 and 33, and for example, the third guide surface portion 34 may be omitted (not shown).

Further, in the fixing device 8 according to the present embodiment, the fixing belt 16 and the pressure roller 17 are arranged substantially in the left-and-right direction, and the fixing straight line L2 extends in the vertical direction, but the present disclosure is not limited to this. For example, the fixing belt 16 and the pressure roller 17 may be arranged generally in the upper-and-lower direction, and the fixing straight line L2 may extend horizontally (not shown). In this case, the floating region 35 of the third guide surface portion 34 may be formed on the downstream side of a vertical line passing through the center 42A of the second circular shape 42 (not shown).

Further, in the fixing device 8 according to the present embodiment, the conveying path 5A between the transfer region N1 and the pressurizing region N2 is curved, and the transfer straight line L1 and the fixing straight line L2 are inclined in opposite directions when viewed from the axial direction, but the present disclosure is not limited thereto. For example, the conveying path 5A between the transfer region N1 and the pressure region N2 may be formed linearly, and the transfer straight line L1 and the fixing straight line L2 may be substantially parallel (not shown).

Further, in the description of the present embodiment, a case where the present disclosure is applied to a printer is shown as an example, but the present disclosure is not limited to this, and the present disclosure may be applied to a multifunction peripheral, a copying machine, a facsimile machine, or the like.

It should be noted that the description of the above embodiments shows one aspect of the fixing device and the image forming apparatus according to the present disclosure, and the technical scope of the present disclosure is not limited to the above embodiments. The disclosure may be variously modified, substituted, or modified without departing from the spirit of the technical idea, and the claims include all embodiments that may fall within the scope of the technical idea.

<Appendix 1> A fixing device according to Appendix 1 is the fixing device including:
a fixing member which heats a toner on a medium while rotating around an axis;
a pressure member which forms a pressurizing region between the fixing member and the pressure member, and pressures the toner on the medium conveyed through the pressurizing region while rotating around an axis;
an entry guide member which is immovably provided on an upstream side of the pressurizing region in a conveying direction of the medium, and has a guide surface which guides the medium conveyed toward the pressurizing region, wherein
the guide surface of the entry guide member includes:
a first guide surface portion extending along a part of a circumference of a first circular shape having a center closer to the fixing member than a fixing straight line obtained by extending a straight line connecting an upstream end and a downstream end of the pressurizing region in the conveying direction; and
a second guide surface portion which continuous to a downstream side of the first guide surface portion in the conveying direction, and extends along a part of a circumference of a second circular shape having a center closer to the pressure member than the fixing straight line, and
a curvature of the second guide surface portion is larger than a curvature of the first guide surface portion.

<Appendix 2> The fixing device according to Appendix 2 is the fixing device according to Appendix 1, wherein
an angle between a guide tangent line passing through a contact point between a leading edge of the medium and the second guide surface portion, and the medium is an acute angle of 30° or less. <Appendix 3> The fixing device according to Appendix 3 is the fixing device according to Appendix 1 or 2, wherein
a radius of the first circular shape is six times a radius of the second circular shape.

<Appendix 4> The fixing device according to Appendix 4 is the fixing device according to any one of Appendixes 1 to 3, wherein
the guide surface of the entry guide member further includes a third guide surface portion which continues to a downstream side of the second guide surface portion in the conveying direction, and
the third guide surface portion has a floating region where the medium is directed to the pressurizing region while floating the medium.

<Appendix 5> The fixing device according to Appendix 5 is the fixing device according to any one of Appendixes 1 to 4, wherein
when the fixing straight line extends in a vertical direction, the floating region of the third guide surface portion is formed closer to a downstream side in the conveying direction than a horizontal line passing through a center of the second circular shape.

<Appendix 6> An image forming apparatus according to Appendix 6 includes the fixing device according to any one of Appendixes 1 to 5.

<Appendix 7> The image forming apparatus according to Appendix 7 is the image forming apparatus according to Appendix 6, including:
an image carrier which carries a toner image while rotating around an axis; and
a transfer member which forms a transfer region between the image carrier and the transfer member, and transfers the toner image to the medium conveyed in the transfer region while rotating around an axis, wherein the fixing device is provided on a downstream side of the transfer region in the conveying direction, and
a transfer straight line obtained by extending a straight line connecting an upstream end and a downstream end of the transfer region in the conveying direction and the fixing straight line are inclined in opposite directions as viewed from an axial direction.

What is claimed is:

1. A fixing device comprising:
a fixing member which heats a toner on a medium while rotating around an axis;
a pressure member which forms a pressurizing region between the fixing member and the pressure member, and pressures the toner on the medium conveyed through the pressurizing region while rotating around an axis;
an entry guide member which is immovably provided on an upstream side of the pressurizing region in a conveying direction of the medium, and has a guide surface which guides the medium conveyed toward the pressurizing region, wherein
the guide surface of the entry guide member includes:
a first guide surface portion extending along a part of a circumference of a first circular shape having a center closer to the fixing member than a fixing straight line obtained by extending a straight line connecting an upstream end and a downstream end of the pressurizing region in the conveying direction; and
a second guide surface portion which continuous to a downstream side of the first guide surface portion in the conveying direction, and extends along a part of a circumference of a second circular shape having a center closer to the pressure member than the fixing straight line, and
a curvature of the second guide surface portion is larger than a curvature of the first guide surface portion.

2. The fixing device according to claim 1, wherein
an angle between a guide tangent line passing through a contact point between a leading edge of the medium and the second guide surface portion, and the medium is an acute angle of 30° or less.

3. The fixing device according to claim 1, wherein
a radius of the first circular shape is six times a radius of the second circular shape.

4. The fixing device according to claim 1, wherein
the guide surface of the entry guide member further includes a third guide surface portion which continues to a downstream side of the second guide surface portion in the conveying direction, and
the third guide surface portion has a floating region where the medium is directed to the pressurizing region while floating the medium.

5. The fixing device according to claim 4, wherein
when the fixing straight line extends in a vertical direction, the floating region of the third guide surface portion is formed closer to a downstream side in the conveying direction than a a horizontal line passing through a center of the second circular shape.

6. An image forming apparatus comprising:
the fixing device according to claim 1.

7. The image forming apparatus according to claim 6, comprising:
an image carrier which carries a toner image while rotating around an axis; and
a transfer member which forms a transfer region between the image carrier and the transfer member, and transfers the toner image to the medium conveyed in the transfer region while rotating around an axis, wherein
the fixing device is provided on a downstream side of the transfer region in the conveying direction, and
a transfer straight line obtained by extending a straight line connecting an upstream end and a downstream end of the transfer region in the conveying direction and the fixing straight line are inclined in opposite directions as viewed from an axial direction.
